(19) United States
(12) Patent Application Publication
(10) Pub. No.: US 2022/0377407 A1
(43) Pub. Date: Nov. 24, 2022

(54) DISTRIBUTED NETWORK RECORDING SYSTEM WITH TRUE AUDIO TO VIDEO FRAME SYNCHRONIZATION

(71) Applicant: DELUXE MEDIA INC., Burbank, CA (US)

(72) Inventors: Andriy Marchuk, Santa Monica, CA (US); Gregory J. Taieb, Los Angeles, CA (US); Igor Skakovskyi, Los Angeles, CA (US); Stefan Lazarevic, Belgrade (RS); Max Podkosov, Voronezh (RU)

(21) Appl. No.: 17/327,373

(22) Filed: May 21, 2021

(51) Int. Cl. H04N 21/43; H04H 60/04; H04N 21/2187; H04N 21/854

(52) U.S. Cl. CPC H04N 21/43076; H04H 60/04; H04N 21/2187; H04N 21/854

(57) ABSTRACT

A remote voice recording is synchronized to video using a cloud-based virtual recording studio within a web browser to record and review audio while viewing the associated video playback and script. All assets are accessed through or streamed within the browser application, thereby eliminating the need for the participants to install any applications or store content locally for later transmission. Recording controls, playback/record status, and audio timeline and script edits are synchronized across participants and may be controlled for all participants remotely by a sound engineer so that each participant sees and hears the section of the program being recorded and edited at the same time. High-resolution audio files for dubbing video are created and time synchronized to the relevant video frames.

### CROSS-REFERENCE TO RELATED APPLICATIONS

This application is related to U.S. patent application Ser. No. ______(identified by Attorney Docket No. P291899.US.01) filed 21 May 2021 entitled “Distributed network recording system with single user control”; U.S. patent application Ser. No. ______(identified by Attorney Docket No. P291900.US.01) filed 21 May 2021 entitled “Distributed network recording system with multi-user audio manipulation and editing”; and U.S. patent application Ser. No. ______(identified by Attorney Docket No. P291901.US.01) filed 21 May 2021 entitled “Distributed network recording system with synchronous multi-actor recording”, each of which is hereby incorporated herein by reference in its entirety.

### TECHNICAL FIELD

The technology described herein relates to systems and methods for conducting a remote audio recording session for synchronization with video.

### BACKGROUND

Audio recording sessions are carried out to digitally record voice-artists for a number of purposes including, but not limited to, foreign language dubbing, voice-overs, automated dialog replacement, or descriptive audio for the visually impaired. Recording sessions are attended by the actors/performers, one or more engineers, other production staff, and producers and directors. The performer watches video playback of the program material and reads the dialog from a script. The audio is recorded in synchronization with the video playback to replace or augment the existing program audio. Such recording sessions typically take place in a dedicated recording studio. Participants all physically gather in the same place. Playback and monitoring is then under the control of the engineer. In the studio, the audio recording is of broadcast or theater technical quality. The recorded audio is also synchronized with the video playback as it is recorded and the audio timeline is captured and provided to the engineer for review and editing.

The information included in this Background section of the specification, including any references cited herein and any description or discussion thereof, is included for technical reference purposes only and is not to be regarded subject matter by which the scope of the invention as defined in the claims is to be bound.

### SUMMARY

The systems and methods described in the present disclosure enable remote voice recording synchronized to video using a cloud-based virtual recording studio within a web browser to record and review audio while viewing the associated video playback and script. All assets are accessed through or streamed within the browser application, thereby eliminating the need for the participants to install any applications or store content locally for later transmission. Recording controls, playback/record status, audio channel configuration, volume, audio timeline, script edits, and other functions are synchronized across participants and may be controlled for all participants remotely by a designated user, typically a sound engineer, so that each participant sees and hears the section of the program being recorded and edited at the same time.

In one exemplary implementation, a method for implementing a remote audio recording session performed by a server computer is provided. The server computer is connected to a plurality of user computers over a communication network. A master recording session is generated, which corresponds to video content stored in a storage device accessible by the server computer. The master recording session and the video content over the communication network are made accessible to one or more users with respective computer devices at different physical locations from each other and from the server computer. High-resolution audio data of a recording of sound created by one user corresponding to the video content and recorded during playback of the video content is received by the server computer. The high-resolution audio data includes a time stamp synchronized with at least one frame of the video content. The high-resolution audio data is received by the server computer as discrete, sequential chunks of audio data corresponding to short, sequential time segments of the recording.

In another exemplary implementation, a method for implementing a remote audio recording session on a first computer associated with a first user is provided. The remote audio recording session is managed by a server computer connected to a plurality of user computers, including the first computer, over a network. The first computer connects to the server computer via the communication network and engages in a master recording session managed by the server computer. The master recording session corresponds to video content stored in a central storage device accessible by the server computer. A transmission of the video content is received over the over the communication network from the sever computer. Sound corresponding to the video content, created by the first user, and transduced by a microphone is recorded. A time stamp is created within the recorded sound that is synchronized with at least one frame of the video content. A high-resolution audio file of the recorded sound including the corresponding time stamp is stored as discrete, sequential chunks of audio data corresponding to short, sequential time segments of the recording in a local memory. Upload instructions are received over the communication network from the server computer. The sequential chunks of audio data are transmitted to the server computer serially.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

FIG. 1 is a schematic diagram of an embodiment of a system for conducting a remote audio recording session synchronized with video.

FIG. 2 is a schematic diagram of an example graphic user interface for a conducting a remote audio recording session among a number of user computer devices.

FIG. 3 is a schematic diagram detailing and exemplary server computer for use in conducting a remote audio recording session and its interaction with two client user devices.

FIG. 4 is a flow diagram of communication of session states between the server computer and a number of user computer devices.

FIG. 5 is a flow diagram of an exemplary method for recording high-resolution audio on a user computer device during a remote audio recording session and efficiently transferring the high-resolution audio data to the server computer.

FIG. 6 is a schematic diagram of a computer system that may be either a server computer or a client computer configured for implementing aspects of the recording system disclosed herein.

### DETAILED DESCRIPTION

In the post-production process of film and video creation, the raw film footage, audio, visual effects, audio effects, background music, environmental sound, etc. are cut, assembled, overlayed, color-corrected, adjusted for sound level, and subjected to numerous other processes in order to complete a finished film, television show, video, or other audio-visual creation. As part of this process, a completed film may be dubbed into any number of foreign languages from the original language used by actors in the film. Often a distributed workforce of foreign freelance translators and actors are used for foreign language dubbing. In such scenarios, the translators and foreign language voice actors are often access video and audio files and technical specifications for a project through a web-based application that streams the video to these performers for reasons of security to prevent unauthorized copies of the film to be made. The foreign language actors record their voice performances through the web-based application. Often these recordings are performed without supervision by a director or audio engineer. Further, the recording quality through web-based browser applications is not of industry standard quality because the browser applications downsample and compress the recorded audio for transmission to a secure server collecting the voice file.

Other post-production audio recording needs arise when the original audio recording is faulty for some reason. For example, unwanted environmental noises (e.g., a car alarm) were picked up by the microphone during an actor's performance, sound levels were too low (or too high), the director ultimately did not like the performance by the actor in a scene, etc. Bringing actors, directors, audio engineers, and others back together post production to a studio to fix audio takes in scenes is expensive and time consuming. However, it is usually the only way to achieve a full, high-resolution audio recording. Similar to the issues with foreign language audio dubbing described above, attempts to record remotely over a network have been performed with lossy compression files, such as Opus, to allow for low latency in transmission in an attempt to achieve approximate synchronization with the corresponding video frames. However, bandwidth and hardware differences can cause a greater delay due to buffering for one actor but not for another such that the dialog each records is not in synch with the other. There is always some lag due to the network bandwidth limitations on either end as well as encoding, decoding, and compressing the audio files. Thus, synchronization is generally not achieved and an audio engineer must spend significant time and effort to properly synchronize the audio recordings to the video frames. Also, sound captured and transmitted by streaming technologies is compressed and lossy; it cannot be rendered in full high-resolution, broadcast or theater quality and is subject to further quality degradation if manipulated later in the post production process. Further, if a director is involved in managing the actor during the audio dubbing process, there is usually a discrepancy between the streaming video playback viewed by the director and the streaming sound file received from the actor. The audio is out of synch with the video and the director is unable to determine whether the audio take synchronizes with the lip movement of the actor in the film content and whether another take is necessary.

The distributed network recording system disclosed herein addresses these problems and provides true synchronization between the audio recorded by the actor and the frames of a portion of the film content being dubbed. The system provides for the frame-synchronized recording of lossless audio files in full 48 kHz/24 bit sound quality, which is the film industry standard for high-resolution recorded audio files. As described in greater detail herein, the system controls a browser application on an actor's computer to record and cache a time-stamped, frame-synchronized, lossless, audio file locally and then upload the lossless audio file to a central server. The system further allows for immediate, in-session review of the synchronized audio and video among all session participants to determine whether a take is accurate and acceptable or whether additional audio recording takes are necessary. This functionality is provided by sending a compressed, time-stamped proxy audio file of the original lossless recording to each user device participating in the recording session, e.g., an audio engineer, multiple actors, a director, etc. The proxy audio file can be reviewed, edited, and manipulated by the participants in the recording session and final time synchronized edit information can be saved and associated with the original, lossless audio file to script the final audio edit for the dubbed film content. Additional detailed description of this process is provided further herein.

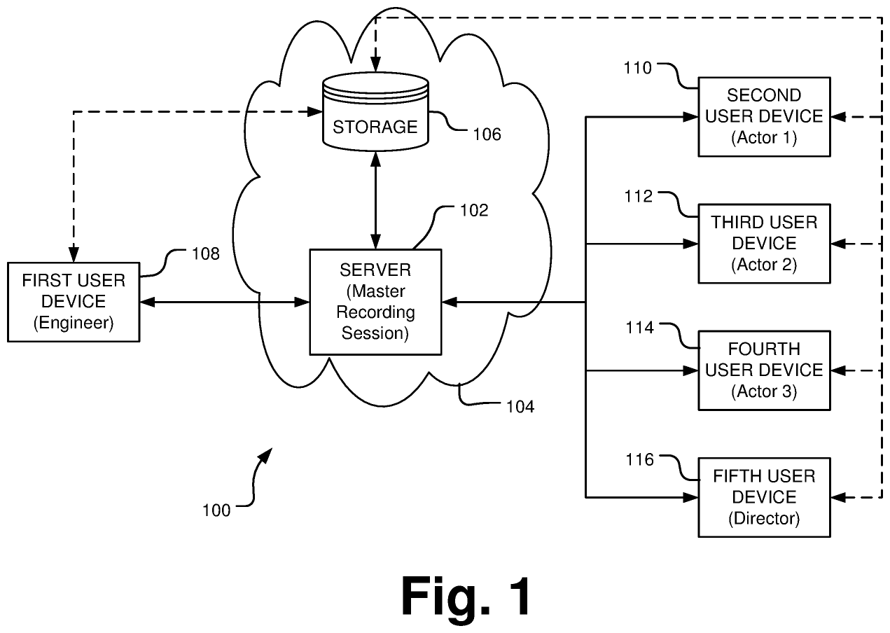

An exemplary distributed network recording system 100 for capturing high-resolution audio from a remotely located actor is depicted in FIG. 1. The system 100 is controlled by a server computer 102 that instantiates a master recording session. The server computer 102 also acts as a communication clearinghouse within the communication network 104, e.g., the Internet “cloud,” between devices of the various participants in the master recording session. The server computer 102 may be a single device that directly manages all communications with the participant devices or it may be a collection of distributed server devices that work in cooperation with each other to enhance speed of delivery of data, e.g., primarily video/audio files to each of the participant devices. For example, the server computer 102 may comprise a host server that manages service to and configuration of a web browser interface for each of the participant devices. Alternatively, the server computer 102 may be in the form of a scalable cloud hosting service, for example, Amazon Web Services (AWS). In addition, the server computer 102 may include a group of geographically distributed servers forming a content delivery network (CDN) that each store a copy of the video files used in the master recording session. Geographic distribution of the video files allows for lower time latency in the streaming of video files to participant devices.

The server 102 is also connected to a storage device 106 that provides file storage capacity for recorded audio files, proxy audio files as further described below, metadata collected during a recording session, a master digital video file of the film being dubbed, application software objects and modules used by the server computer 102 to instantiate and conduct the master recording session, and other data and media files that may be used in a recording session. As with the server computer 102, the storage device 106 may be a singular device or multiple storage devices that are geographically distributed, e.g., as components of a CDN.

A number of participant or user devices may be in communication with the server computer 102 to participate in the master recording session. For example, each of the user devices may connect with the server computer over the Internet through a browser application by accessing a particular uniform resource locator (URL) generated to identify the master recording session. A first user device 108 may be a personal computer at a remote location associated with an audio engineer. As described further herein, the audio engineer may be provided with credentials to primarily control the master recording session on user devices of other participants. A second user device 110 may be a personal computer at a remote location associated with a first actor to be recorded as part of the master recording session. A third user device 112 may be a personal computer at a remote location associated with a second actor to be recorded as part of the master recording session. A fourth user device 114 may be a personal computer at a remote location associated with a third actor to be recorded as part of the master recording session. A fifth user device 116 may be a personal computer at a remote location associated with a director of the film reviewing the audio recordings made by the actors and determining acceptability of performances during the master recording session.

As indicated by the solid communication lines in FIG. 1, the user devices 108, 110, 112, 114, 116 all communicate with the server computer 102, which transmits control information to each of the user devices 108, 110, 112, 114, 116 during the master recording session. Likewise, each of the user devices 108, 110, 112, 114, 116 may transmit control requests or query responses to the server computer 102, which may then forward related instructions to one or more of the user devices 108, 110, 112, 114, 116 (i.e., each of the user devices 108-, 110, 112, 114, 116 is individually addressable and all are collectively addressable). Session data received from any of the user devices 108, 110, 112, 114, 116 received by the server computer 102 may be passed to the storage device 106 for storage in memory. Additionally, as indicated by the dashed communication lines in FIG. 1, each of the user devices 108-116 may receive files directly from the storage device 106 or transmit files directly to the storage device 106, for example, if the storage device 106 is a group of devices in a CDN. For example, the storage device 106 in a CDN configuration may directly stream the video film content being dubbed or proxy audio files as further described herein to the user devices 108, 110, 112, 114, 116 to reduce potential latency in widely geographically distributed user devices 108, 110, 112, 114, 116. Similarly, the user devices 108, 110, 112, 114, 116 may upload audio files created locally during the master recording session directly to the storage device 106, e.g., in a CDN configuration at the direction of the server computer 102.

As noted, each of the user devices 108, 110, 112, 114, 116 may participate in a common master recording session within a web browser application instantiated locally on each user device. Each user device 108, 110, 112, 114, 116 may accesses the master recording session at a designated URL that directs to the closest server on the CDN. The session may be rendered on the user devices 108, 110, 112, 114, 116 via an application program running within the browser program. For example, the master recording session environment for each user device 108, 110, 112, 114, 116 may be built using the JavaScript React library. The necessary JavaScript objects for master recording session environment are transmitted to each user device 108, 110, 112, 114, 116 from the CDN server and the environment is displayed within the browser on each user device 108, 110, 112, 114, 116.

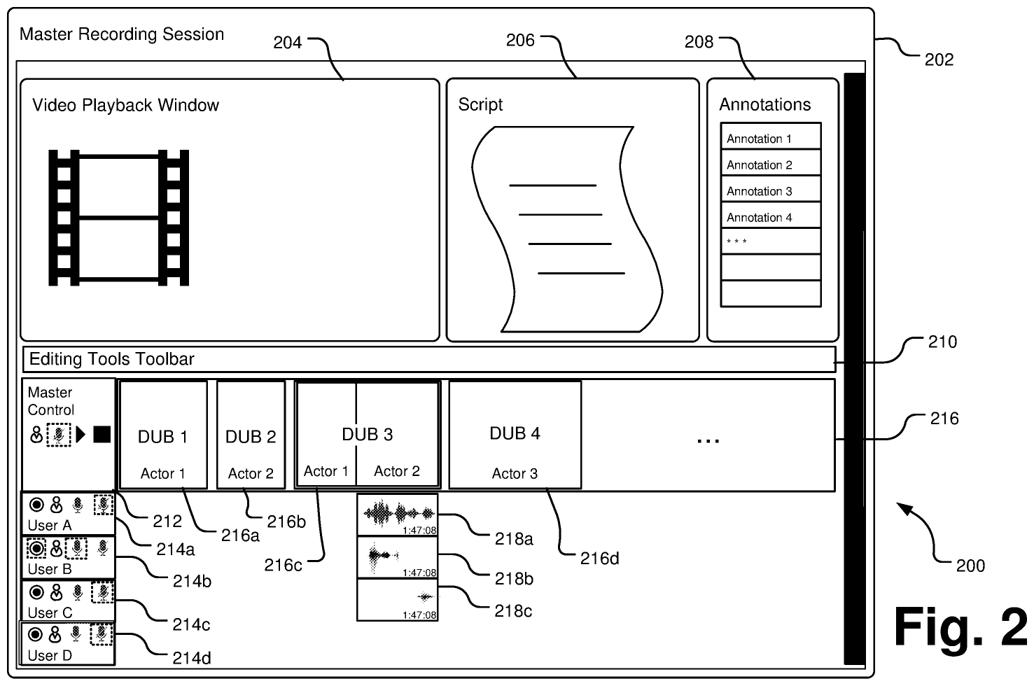

An exemplary implementation of a master recording environment 200 rendered as a web page by a web browser application is depicted in FIG. 2. The master recording environment 200 may include a video playback window 204 for presenting a streaming video file of the film or video content that is being dubbed. As a scene plays in the video playback window 204, a user, e.g., an actor, can record their lines in conjunction with the video of the scene and match their words to the images, e.g., mouth movements, on the screen. The relevant portion of the script that the actor is reading for dubbing may be presented in a script window 206. If the actor is overdubbing their own original take, the script may be a portion of the original script. If the actor is dubbing a scene in a different language, e.g., for localization, the script may be presented in a foreign language with respect to the original language of the film. The master recording environment 200 may also include an annotation window 208, which may be used by any of the users to provide comment or notes related to specific audio dubs.

The master recording environment 200 may further include an editing toolbar 210, which may provide tools for an audio engineer to adjust and edit various aspects of an audio dub performed by a user and captured by the distributed network recording system. The tools may include controls such as play, pause, fast forward, rewind, stop, trim, fade, loudness, compression, equalization, duplicate, etc. Editing tasks may be performed during the recording session or at a later time.

The master recording environment 200 may also provide a master control toolbox 212 that allows a person with a control role, e.g., the audio engineer, to control various aspects of the environment for all users. The various participants (e.g., the sound engineer, a director, multiple actors, etc.) may be identified as separate Users A-D (214a-d) within the master recording environment 200. Each user can see all other users logged into the recording session and their present activity. The activities of users may also be controlled by one or more of the users. For example, the audio engineer could mute the microphones for all participants (as indicated by the dotted lines around the muted microhone icon) except for one user (e.g., User B 214a) who is being recorded (as indicated by the dotted lines around a record icon and active microphone icon). It may be important for the user recording the voice dub to hear previously recorded dialog of other actors in a scene or other sound to guide the performance without distraction from other participants speaking. However, any participant can unmute their microphone locally at any time if they need to speak and be heard by all. Once User B 214 completes an audio dub, the audio engineer (e.g., User A) can reactivate the microphones of all participants through the master control panel 212.

Each section of video content that has been designated for dubbing may be presented within the master recording environment 200 as a dub list 216. Each dub activity 216a-d may be separately represented in the dub list 216 with an explanation of the recording needed and an identification of the actor or actors needed to participate. For example, dub activity Dub 1 (216a) and dub activity Dub 2 (216b) only require the participation and recording of one actor each, while dib activity Dub 3 (216c) is an interchange between two actors and requires their joint participation, e.g., to carry out a dialogue between two characters. Dub activity Dub 4 (216d) in the dub list 216 is shown requiring the talents of a third actor. If this third actor has no interactive dialogues with other actors, the third actor need not be present at this master recording session, but could rather take part in another master recording session at a different time. However, the state of the master recording environment 200 would be recreated from a saved state of the present recording session saved in the storage device 106.

The master recording environment 200 may also provide a visualization of audio recorded by any of the participants in a session to aid the audio engineer in editing. For example, if the audio engineer is User A (241a), a first visual representation 218a of a complete audio recording for a dub activity may be displayed under the relevant dub activity. The first visual representation 218a may provide for a visualized editing interface for the sound engineer to use in conjunction with the tolls in the editing toolbar. Other visual representations 218b, 218c related to the recordings of particular users within the master recording environment 200 may also be presented.

When conducting a recording session within the master recording environment 200, the participants may also be connected with each other simultaneously via a network video conferencing platform (e.g., Zoom, Microsoft Teams, etc.) in order to communicate in conjunction with the activities of the master recording session. While such an additional conferencing platform could be incorporated into the distributed network recording system 100 in some embodiments, such is not central or necessary to the novel technology disclosed herein. It is desirable that participants, particularly actors recording dialogue, use headphones for listening to communications from other participants over the conferencing platform and playback of the video content within the master recording environment 200 to avoid the possibility of such addition sound to be picked up by the microphone when recording. The master recording environment 200 may also be configured to send sound from the microphone to the headphones of the actor during a recording session, as well as to the recording function described later herein, so the actor can hear his or her own speech.

One of the Users A-D (214a-d), e.g., the audio engineer User A (214a), may be designated as a “controller” of the master recording environment 200 and, through selection of control options in the master recording environment 200, can orchestrate the recording session. For example, if the audio engineer initiates playback of the video content within the master recording environment 200, the instruction is transmitted from the first user device 208 to the master recording session on the server computer 102 and then transmitted to each of the other user devices 110, 112, 114, 116 participating in the recording session (214b-d). The video playback command from the audio engineer is then actuated and video content is played in the video playback window 204 in the master recording environments 200 on each user device 110, 112, 114, 116.

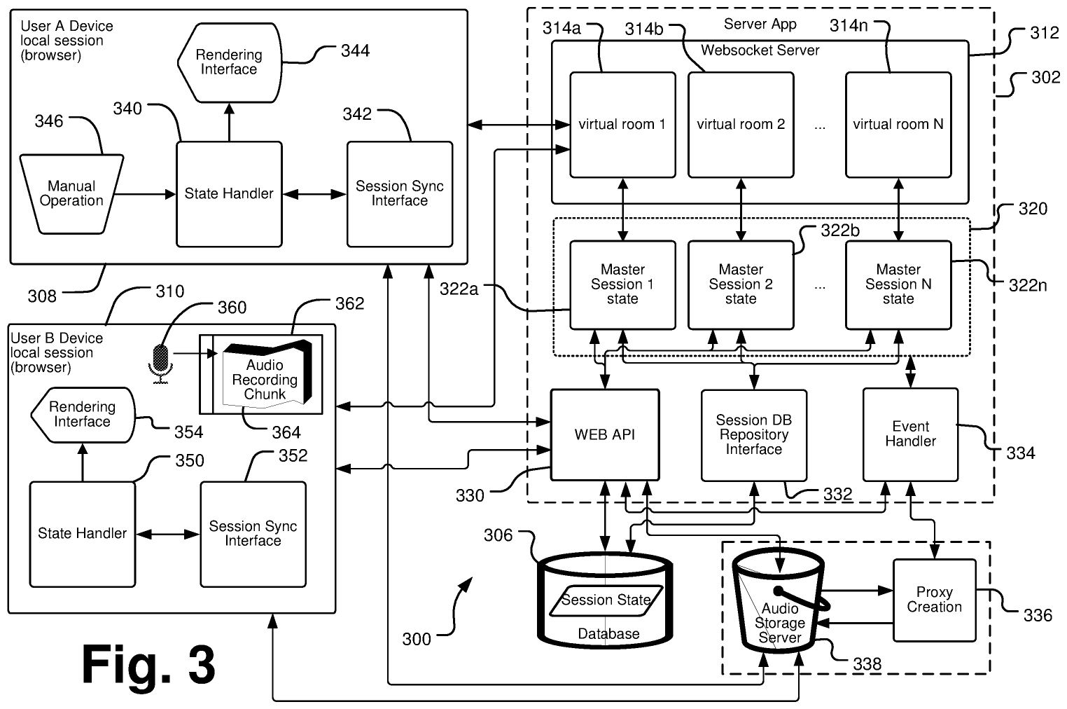

An exemplary embodiment of the system and, in particular, a more detailed implementation of a server configuration is presented in FIG. 3. The server computer 302 is indicated generally by the dashed line bounding the components or modules that make up the functionality of the server computer 302. The components or modules comprising the server computer 302 may be instantiated on the same physical device or distributed among several devices which may be geographically distributed for faster network access. In the example of FIG. 3, a first user device 308 and a second user device 310 are connected to the server computer 302 over a network such as the Internet. However, as discussed above with respect to FIG. 1, any number of user devices can connect to a master recording session instantiated on the server computer 302.

The server computer 302 may instantiate a Websocket application 312 or similar transport/control layer application to manage traffic between user devices 308, 310 participating in a master recording session. Each user device 308, 310 may correspondingly instantiate the recording studio environment locally in a web browser application. A session sync interface 342, 352 and a state handler 340, 350 may underly the recording studio environment on each user device 308, 310. The session sync interface 242, 252 communicates with the Websocket application 312 to exchange data and state information. The state handler 340, 350 maintains the state information locally on the user devices 308, 310 both as changed locally and as received from other user devices 308, 310 via the Websocket application 312. The current state of the master recording session is presented to the users via rendering interfaces 344, 354, e.g., as interactive web pages presented by the web browser application. The interactive web pages are updated and reconfigured to reflect any changes in state information received from other user devices 308, 310 as maintained in the state handler 340, 350 for the duration of the master recording session.

The Websocket application 312 may be a particularly configured Transmission Control Protocol (TCP) server environment that listens for data traffic from any user device 308, 310 participating in a particular recording session and passes the change of state information from one user device 308, 310 to the other user devices 308, 310 connected to the session. In this manner, the Websocket application 312 facilitates the abstraction of a single recording studio environment presented within the browser application, i.e., rendering interfaces 344, 354 on each user device 308, 310. Namely, whatever action taken within the rendering interface 344, 354 by one user on a local user device 308, 310 that is coded for replication on all browser interfaces is transmitted to all the other user devices 308, 310 and presented in rendering interfaces 344, 354 thereon.

The server computer 312 may instantiate and manage multiple master recording session states 322a/b/n in a session environment 320 either simultaneously or at different times. If different master recording session states 322a/b/n operate simultaneously, the Websocket application 312 creates respective “virtual rooms” 314a/b/n or separate TCP communication channels for managing the traffic between user devices 308, 310 associated with a respective master recording session state 322a/b/n. Each master recording session state 322a/b/n listens to all traffic passing through the associated virtual room 314a/b/n and captures and maintains any state change that occurs in a particular recording session 322a/b/n. For example, if a user device 308 (e.g., an audio engineer) associated with the first virtual room 314a initiates a manual operation 346, e.g., starts video playback for all user devices 308, 310 associated with the first virtual room 314a and activates a microphone of another one of the users 310 (e.g., an actor), the first master recording session state 322a notes and saves these actions. Similarly, if an audio engineer at a user device 308 edits an audio file, the edits made to the audio file, e.g., in the form of metadata describing the edits (video frame association, length of trim, location of trim in audio recording, loudness adjustments, etc.), are captured by the first master recording session state 322a.

Each master recording session state 322a/b/n communicates with a session state database server 306 via a session database repository interface 332. The session state database server 306 receives and persistently saves all the state information from each master recording session state 322a/b/n. The session state database server 306 may be assigned a session identifier, e.g., a unique sequence of alpha-numeric characters, for reference and lookup in the session state database server 306. In contrast, state information in each master recording session state 322a/b/n persists only for the duration of a recording session. If a recording session ends before all desired dubbing activities are complete, a new master recording session state 322a/b/n can be instantiated later by retrieving the session state information using the previously assigned session identifier. All the prior state information can be loaded into a new master recording session state 322a/b/n and the recording session can pick up where it left off. Further, an audio engineer can open a prior session, either complete or incomplete, in a master recording session state 322a/b/n and use any interface tools to edit the audio outside of a recording session by associating metadata descriptors (e.g., fade in, fade out, trim, equalization, compression, etc.) using a proxy audio file provided locally as further described herein.

The session database repository interface 332 is an application provided within the server computer 312 as an intermediary data handler and format translator, if necessary, for files and data transferred to and from the session state database server 306 within the master recording session state 322a/b/n. Databases can be formatted in any number of ways (e.g., SQL, Oracle, Access, etc.) and session database repository interface 332 is configured to identify the type of database used for the session state database server 332 and arrangement of data fields therein. The session data repository interface 332 can then identify desired data within the session state database server 306 and serve requested data, appropriately transforming the format if necessary, for presentation to participants through the web browser applications on user devices 308, 310. Similarly, as new metadata describing state changes is generated during a master recording session state 322a/b/n, the session database repository interface 332 will arrange and transform the metadata into an appropriate format for storage on the type of database being used as the session state database server 306. In the context of audio dubbing for film and video, the audio data may be saved, for example, in Advanced Authoring Format (AAF), a multimedia file format for professional video post-production and authoring designed for cross-platform digital media and metadata interchange.

The server computer 312 may also be configured to include a Web application program interface (Web-API) 330. The Web-API 330 may be provided to handle direct requests for action from user devices 308, 310 that do not need to be broadcast to other user devices 308, 310 via the Websocket server 302. For example, the Web API 330 may provide login interface for users and the initial web page HTML code for instantiation of the recording studio environment on each user device 308, 310. In another example, if a user device 308, 310 has recorded a high-resolution audio file, the audio file is not intended to be shared among the participants in a high-resolution form (as further described below). Rather, the high-resolution audio file may be directed for storage by the Web API 330 within a separate audio storage server 338 for access by any audio editing session at any time on any platform. The recording studio environment present on each user device 308, 310 may be configured to direct certain process tasks to the Web API 330 as opposed to the Websocket application 312, which is primarily configured to transmit updates to state information between the user devices 308, 310.

In the case of receipt of notice of transfer of audio files to the audio storage server 338, the event handler module 334 may actuate a proxy file creation application 236 that identifies new files in the audio storage server 338. If multiple audio files are determined to be related to each other, e.g., audio files constituting portions of a dub activity from the same actor (user device), the proxy file creation application 336 may combine the related files into a single audio file reflective of the entire dub activity. The proxy file creation application 336 may further create a proxy file of each dub activity in the form of a compressed audio file that can easily and quickly be streamed to each user device 308, 310 participating in the recording session for local playback. For the purposes of conducting the master recording session, the full, high-resolution audio file is not needed by any of the participants. The lower-quality, smaller file size audio files are adequate for review by actors and directors and for initial editing by the audio engineer. Such smaller file sizes can also be stored in a browser session cache in local memory by each user device 308, 310 and be available for playback and editing throughout the master recording session. Once a proxy audio file is created by the proxy file creation application 336, the event handler module 334 may alert the appropriate master session state 322a/b/c that the proxy audio file is complete and available. The applicable master session state 322a/b/c may then alert each user device of the availability of the proxy audio file on the audio storage server 338 and provide a uniform resource identifier for each user device 308, 310 to download the proxy audio file from the audio storage server 338 via the Web API 330.

The server computer 300 may further be configured with an event handler module 334. As with other components of the server computer 300, the event handler module 334 may be on a common device with other server components or it may be geographically distant, for example, as part of a CDN. The event handler module 334 may be configured to manage asynchronous processes related to a master recording session. For example, the event handler module 334 may receive notice from the proxy file creation application that an audio file has been downloaded to the audio storage server 338. Alternatively or additionally, the event handler module 334 may monitor the state information for each master recording session state 322a/b/n in the session environment 320 for indication of completion of a high-resolution audio recording or other event related to a task that it is configured to manage.

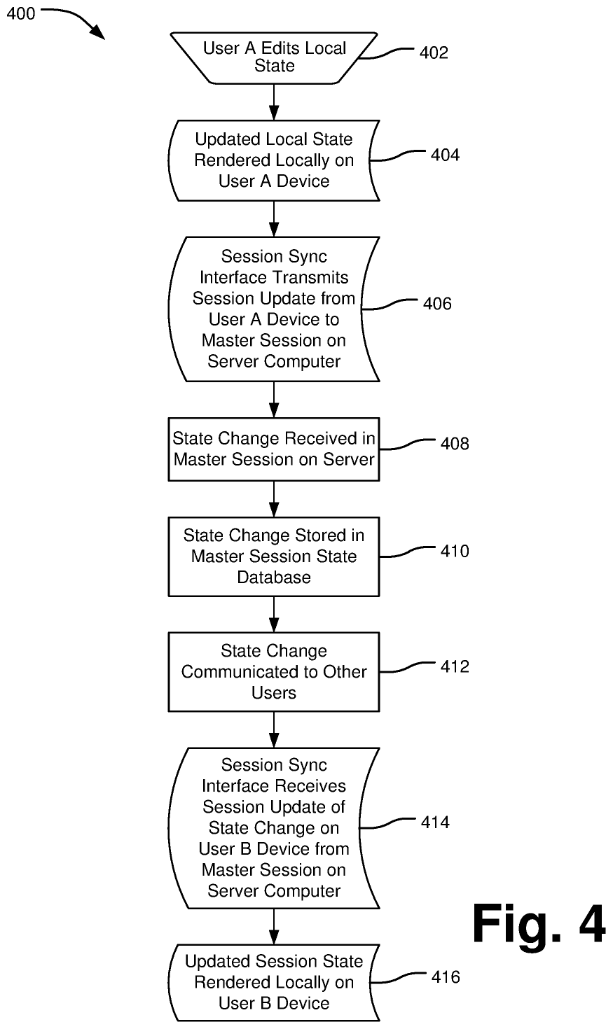

An exemplary method 400 of interaction between user devices 308, 310 and the computer server 302 is depicted in FIG. 4 and is described in the context of FIG. 3. In an initial step 402, a user takes some action on a user device within the recording session environment on the user device which changes the local state. For example, and audio engineer on the User A device 308 may begin playback of video content within the rendering interface 224 (i.e., the web page presentation of the recording session environment). In step 404, the local state in the state handler 342 on the User A device 308 changes to indicate that video playback has been actuated. The session sync interface 342 is engaged to transmit this change of state information to the server computer 312 to update the master session state 322 for the first virtual room 314a to which the User A device 308 is connected as indicated in step 406. As noted above, such state information, typically in the form of metadata passes through the virtual room 314a of the Websocket application 312 on the computer server 302. Upon receipt of metadata from user devices, the master session state 322 is update as indicated in step 408 and the state change is stored in the master session state database 306 as indicated in step 410. As noted above, the updated state data may first be processed by the session data repository interface 332 to appropriately format the data for storage in the master session state database 306.

Simultaneously, the Websocket application 312 transmits the updated state data from the User A device 308 received in the first virtual room 314a to all user devices logged into the first virtual room 314a as indicated in step 412. In the example of FIG. 3, only one other user, the User B device 310, is logged into the master recording session of the first virtual room 314 but, as noted previously, many additional users can participate in the recording session simultaneously (e.g., as shown in FIG. 1) and would all receive the transmission of updated session state information indicated in step 412. Once the updated session state information is received by the session sync interface 352 on the User B device 310, the state of the local session in the session handler 350 is updated to reflect the state change on the User A device 308 and the state change is reflected in the rendering interface 354 on the User B device 310 as indicated in step 416. In the present example, video playback would begin in the video playback window of the recording session environment web page presented by the web browser on the User B device 310.

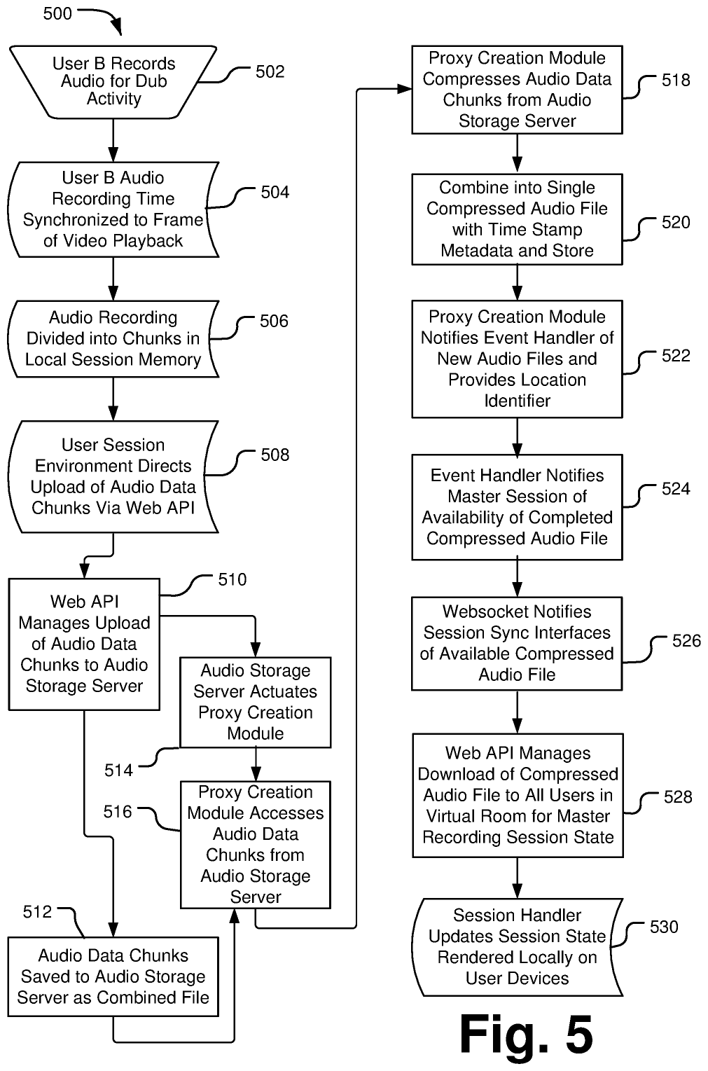

With this background of the master recording session platform, an exemplary implementation for remote network recording of high-resolution audio synchronized to a video scene may be understood. FIG. 5 depicts an exemplary recording process 500 in the context of the user device 308, 310 and server computer 302 relationships of FIG. 3. In an actual recording session, the audio engineer (e.g., User A device 308) initiates recording by activating the microphone 360 of an actor (e.g., User B device 310) and starting playback of the video content associated with a dub activity. The video content playback and microphone actuation on the actor device 310 may not be synchronous with the video playback on any other participant device (e.g., other actors, a director, or even the audio engineer). However on the User B device, the recording can be synchronized to a frame of the video and time stamped when the microphone is actuated as indicated in step 504. The recording session environment on the User B device 310 (and every participant device) is configured to record the dub activity in high-resolution audio data (i.e., at least 24 bit/48 kHz quality, which is the standard for professional film and video production, e.g., a WAV file).

The recorded audio data is saved to a session cache 362 within cache allotted to the browser application by the user device 310 and may be stored as raw pulse code modulated (PCM) data. However, the recorded audio data is stored in the session cache 362 in audio data chunks 364 rather than as a single file of the entirety of the dub activity. By portioning and saving the recorded audio data in separate sequential chunks, audio data can be uploaded to the audio storage server 338 during the recording of the dub activity before the actor has completed the dub activity. By uploading the audio data chunks 364 immediately, rather than waiting for the entire dub activity to be completed and then uploading a single large file, latency in response within the distributed network recording system can be reduced. The functionality underlying the recording session environment may be configured to direct the upload of the audio data chunks 364 being cached on the User B device 310 via the Web API 330 as indicated in operation 508. As discussed above, since the upload of audio files is not a state change within the recording session environment that needs to be reflected on all user devices, but rather a data transfer interaction with a single user device, the Websocket application is not involved in this task.

The Web API 330 may then manage and coordinate the upload of the audio data chunks 364 sequentially to the audio storage server 338 as indicated in operation 510. In one exemplary implementation, the audio data chunks 364 may be substantially 5 Mb in size. This file size is somewhat arbitrary. For example, the file sizes could be anywhere between 1 Mb and 10 Mb or more. The goal is to break the audio date into segments of a file size that can be quickly uploaded to the audio storage server 338 while the actor on the User B device 310 continues to record and further while videoconference data is simultaneously streaming to and received by the User B device 310, consuming a portion of the available transmission bandwidth. A 5 Mb file size corresponds to about 35 seconds of high-resolution mono audio (i.e., single channel, 24 bit/48 kHz) or about 17.5 seconds of high-resolution stereo audio (i.e., two channel, 24 bit/48 kHz). By breaking the recorded audio into audio data chunks 364 of a manageable size, latency in data transmission of the recorded audio can be minimized. Once received at the server computer 302, the Web API 330 manages the recombination of the audio data chunks 364 into a single file and storage of the audio file in the audio storage server 338 as indicated in operation 512.

Once the audio data chunks 364 are stored and recombined on the audio storage server 338, the audio storage server 338 may provide location identifiers for the audio file on the storage server 338 to the applicable master session state 322a/b/c. The audio storage server 338 may simultaneously actuate the proxy file creation module 336 to begin compression of the audio data chunks 364 as soon as they are stored in the audio storage server 338 as indicated in operation 514. Upon receiving the file location identification in the actuation instructions, the proxy file creation module 336 accesses the audio data chunks 364 of a dub activity sequentially as indicated in operation 516 and makes a copy of the audio data chunks 364 in a compressed format as indicated in operation 518. The compressed audio chunks are then combined into a single file constituting the recorded audio for a single dub activity, including time stamp metadata for synchronizing the recorded audio dub to the corresponding video frames, and stored on the audio storage server 338 as indicated in operation 520.

Once the compressed audio file is created, the proxy file creation module 336 notifies the event handler 334 The event handler 334 then notifies the applicable master session state 322a/b/c of the availability of the compressed audio file on the audio storage server 338 as indicated in operation 524. The Websocket application 312 may then send notice to all the user devices 308, 310 that the compressed audio file is available in the local recording session environment as indicated in operation 526. The Web API 330 then manages the download of the compressed audio file to each of the user devices 308, 310 participating in the master recording session of the first virtual room 214a upon receipt of download request from the user devices 308, 310 as indicated in operation 528. The session handler 340, 350 on each user device 308, 310 may then update the local state and confirm receipt of the compressed audio file to the applicable master session state 322a/b/c and the rendering interfaces 344, 354 may display the availability of the recorded audio file associated with the dub activity for further review and manipulation as indicated in operation 530.

The compression format may be either a lossless or lossy format. In either case, the goal is to reduce the file size of the complete single compressed audio file and minimize the time needed to download the compressed audio file to the user devices 308, 310. For the purposes of a master recording session, the sound quality of the audio file used for review need not be high-resolution. The important aspects are that the recorded audio is synchronized with the video frames being dubbed and that the recorded audio is available to the participants for such review in near real time. For example, in a master recording session, the director may want to immediately review a dub recording take with the actor to confirm accurate lip synchronization, appropriate emotion, adequate sound level, absence of environmental noise, etc., to determine whether the take was adequate or whether a new take is necessary. These performance aspects can be determined without need for a full, high-resolution audio file. Further, while playback of the video with the dubbed audio recording may not be exactly synchronous between each of the user devices 308, 310, e.g., due to network latency, it is close enough for collaborative review of remote participants over the network. Again, the important aspect is that they dubbed audio recording is synchronized with the video playback locally on each user device 308, 310. Similarly, the audio engineer can perform initial audio editing tasks using the lower quality audio files. The edits are saved as metadata coordinated to time stamps in the audio and thus can be easily incorporated into an AAF file associated with the original, high-resolution audio files stored on the audio storage serve 338. In actual practice, the simultaneous download and compression of the audio data chunks 364 results in a compressed audio file ready returned to the user devices 308, 310 within a few seconds of completion of a dub activity. To the participants, the recording of the dub activity is available for review and editing almost instantaneously.

A notable additional advantage of breaking the audio recordings into audio data chunks is enhanced security. A complete audio file of the dub activity never exists on the user device 310. The complete audio recording is transmitted for permanent storage in sections, i.e., the audio data chunks 364. When the audio data chunks 364 reach the audio data server 338, they may be immediately encrypted to prevent possible leaks of elements of the film before it is completed for release and generally to prevent illegal copying of the files. Furthermore, as the audio data chunks 364 are stored in the browser application session cache rather than as files on the user device hard drive (or similar permanent storage memory), as soon as the master recording session is completed and the user closes the web page constituting the recording session environment within the browser application, the audio data chunks 364 on the user device are deleted from the cache and not recoverable on the local user device.

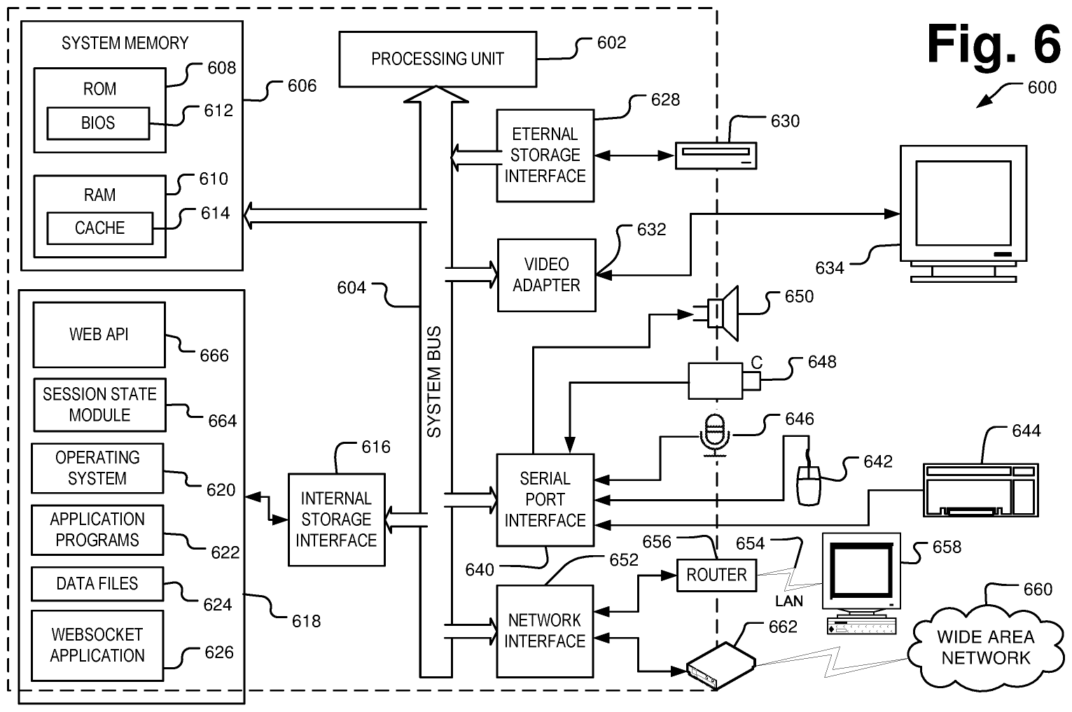

An exemplary computer system 600 for implementing the processes of the distributed network recording system described above is depicted in FIG. 6. The computer device of a participant in the distributed network recording system (e.g., an engineer, editor, actor, director, etc.) may be a personal computer (PC), a workstation, a notebook or portable computer, a tablet PC, or other device, with internal processing and memory components as well as interface components for connection with external input, output, storage, network, and other types of peripheral devices. The server computer system may be one or more computer devices providing web services, database services, file storage and access services, and application services among others. Internal components of the computer system in FIG. 6 are shown within the dashed line and external components are shown outside of the dashed line. Components that may be internal or external are shown straddling the dashed line.

Any computer system 600, regardless of whether configured as a personal computer system for a user, or as a server computer, includes a processor 602 and a system memory 606 connected by a system bus 604 that also operatively couples various system components. There may be one or more processors 602, e.g., a single central processing unit (CPU), or a plurality of processing units, commonly referred to as a parallel processing environment (for example, a dual-core, quad-core, or other multi-core processing device). The system bus 604 may be any of several types of bus structures including a memory bus or memory controller, a peripheral bus, a switched-fabric, point-to-point connection, and a local bus using any of a variety of bus architectures. The system memory 606 includes read only memory (ROM) 608 and random access memory (RAM) 610. A basic input/output system (BIOS) 612, containing the basic routines that help to transfer information between elements within the computer system 600, such as during start-up, is stored in ROM 608. A cache 614 may be set aside in RAM 610 to provide a high speed memory store for frequently accessed data.

A local internal storage interface 616 may be connected with the system bus 604 to provide read and write access to a data storage device 618 directly connected to the computer system 600, e.g., for nonvolatile storage of applications, files, and data, e.g., audio files. The data storage device 618 may be a solid-state memory device, a magnetic disk drive, an optical disc drive, a flash drive, or other storage medium. A number of program modules and other data may be stored on the data storage device 618, including an operating system 620, one or more application programs 622, and data files 624. In an exemplary implementation on a server computer of the system, the data storage device 618 may store the Websocket application 626 for transmission of state changes between the user devices participating in a master recording session, the session state module 664 for maintaining master session state information during a master recording session, and the Web API 666 for managing file transfer of recorded audio data and compressed audio files according to the exemplary processes described herein above. Other modules and applications described herein (e.g., the event handler and the proxy creation module related to the server computer, and the state handler, sync interface, and browser applications on client devices) are not depicted in FIG. 6 for purposes of brevity, but they too may be stored in the data storage device 630. Note that the data storage device 618 may be either an internal component or an external component of the computer system 600 as indicated by the data storage device 618 straddling the dashed line in FIG. 6. In some configurations, there may be both an internal and an external data storage device 618.

The computer system 600 may further include an external data storage device#30. The data storage device 630 may be a solid-state memory device, a magnetic disk drive, an optical disc drive, a flash drive, or other storage medium. The external storage device 630 may be connected with the system bus 604 via an external storage interface 628 to provide read and write access to the external storage device 630 initiated by other components or applications within the computer system 600. The external storage device 630 (and any associated computer-readable media) may be used to provide nonvolatile storage of computer-readable instructions, data structures, program modules, and other data for the computer system 600. Alternatively, the computer system 600 may access remote storage devices (e.g., “cloud” storage) over a communication network (e.g., the Internet) as further described below.

A display device 634, e.g., a monitor, a television, or a projector, or other type of presentation device may also be connected to the system bus 604 via an interface, such as a video adapter 640 or video card. In addition to the monitor 642, the computer system 600 may include other peripheral input and output devices, which are often connected to the processor 602 and memory 606 through the serial port interface 644 that is coupled to the system bus 606. Input and output devices may also or alternately be connected with the system bus 604 by other interfaces, for example, a universal serial bus (USB A/B/C), an IEEE 1394 interface (“Firewire”), a Lightning port, a parallel port, or a game port, or wirelessly via Bluetooth protocol. A user may enter commands and information into the computer system 600 through various input devices including, for example, a keyboard 642 and pointing device 644, for example, a mouse. Other input devices (not shown) may include, for example, a joystick, a game pad, a tablet, a touch screen device, a scanner, a facsimile machine, a microphone, a digital camera, and a digital video camera. Additionally, audio and video devices such as a microphone 646, a video camera 648 (e.g., a webcam), and external speakers 650, may be connected to the system bus 604 through the serial port interface 640 with or without intervening specialized audio or video cards card or other media interfaces (not shown).

The computer system 600 may operate in a networked environment using logical connections through a network interface 652 coupled with the system bus 604 to communicate with one or more remote devices. The logical connections depicted in FIG. 6 include a local-area network (LAN) 654 and a wide-area network (WAN) 660. Such networking environments are commonplace in home networks, office networks, enterprise-wide computer networks, and intranets. These logical connections may be achieved by a communication device coupled to or integral with the computer system 600. As depicted in FIG. 6, the LAN 654 may use a router 656 or hub, either wired or wireless, e.g., via IEEE 802.11 protocols, internal or external, to connect with remote devices, e.g., a remote computer 658, similarly connected on the LAN 654. The remote computer 658 may be another personal computer, a server, a client, a peer device, or other common network node, and typically includes many or all of the elements described above relative to the computer system 600.

To connect with a WAN 660, the computer system 600 typically includes a modem 662 for establishing communications over the WAN 660. Typically the WAN 660 may be the Internet. However, in some instances the WAN 660 may be a large private network spread among multiple locations, or a virtual private network (VPN). The modem 662 may be a telephone modem, a high-speed modem (e.g., a digital subscriber line (DSL) modem), a cable modem, or similar type of communications device. The modem 662, which may be internal or external, is connected to the system bus 618 via the network interface 652. In alternate embodiments the modem 662 may be connected via the serial port interface 644. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method for implementing a remote audio recording session performed by a server computer connected to a plurality of user computers over a communication network, the method comprising:
generating a master recording session corresponding to video content stored in a data storage accessible by the server computer;
providing access to the master recording session and the video content over the communication network to a first user and a second user with respective first and second computer devices at different physical locations from each other and from the server computer;
receiving first high-resolution audio data of a first recording of sound created by the first user corresponding to the video content and recorded during playback of the video content at the first computer device;
receiving second high-resolution audio data of a second recording of sound created by the second user corresponding to the video content and recorded during playback of the video content at the second computer device, wherein
the first high-resolution audio data includes a first time stamp synchronized with at least a first frame of the video content and the second high-resolution audio data includes a second time stamp synchronized with at least a second frame of the video content, and
the first high-resolution audio data and the second high-resolution audio data is received by the server computer as discrete, sequential chunks of audio data corresponding to short, sequential time segments of the recording;
combining, by the server computer, the first high-resolution audio data and the second high-resolution audio data into a single high-resolution audio file synchronized with the video content based on the first time stamp and the second time stamp; and
saving the single high-resolution audio file to a storage device accessible by the server computer.

2. The method of claim 1, wherein the first high-resolution audio data and the second high-resolution audio data each comprise audio recorded at a sample rate of at least 48 kHz and a resolution of at least 24 bits per sample.

3. The method of claim 1, wherein the step of receiving the first high-resolution audio data further comprises receiving the first high-resolution audio data at least partially during playback of the video content.

4. (canceled)

5. The method of claim 1 further comprising encrypting the single high-resolution audio file.

6. The method of claim 1 further comprising
transforming the single high-resolution audio file into a reduced-quality audio file; and
transmitting the reduced-quality audio file over the communication network to each of the first computer device and the second computer device.

7. The method of claim 1, wherein a file size of each of the chunks of audio data is between 1 Mb and 10 Mb.

8. The method of claim 1, wherein the video content is transmitted as a streaming video file for presentation in a browser program on each of the first computer device and the second computer device.

9. The method of claim 1 further comprising
receiving metadata defining edits for application to the high-resolution audio data within the master recording session; and
storing the metadata in a storage device.

10. The method of claim 9 further comprising distributing the metadata received in the master recording session to all of the one or more users accessing the master recording session.

11. A method for implementing a remote audio recording session on a first computer associated with a first user, wherein the remote audio recording session is managed by a server computer connected to a plurality of user computers, including the first computer, over a communication network, the method comprising
connecting to the server computer via the communication network and engaging in a master recording session managed by the server computer, wherein the master recording session corresponds to a video content stored in a central memory accessible by the server computer;
receiving a transmission of the video content over the over the communication network from the server computer;
recording sound created by the first user transduced by a microphone, wherein the recorded sound corresponds to the video content;
creating a time stamp within the recorded sound that is synchronized with at least one frame of the video content;
storing a high-resolution audio file of the recorded sound including the corresponding time stamp as discrete, sequential chunks of audio data corresponding to short, sequential time segments of the recording in a local memory;
receiving upload instructions over the communication network from the server computer;
transmitting the sequential chunks of audio data to the server computer serially;
receiving, from the server computer, a reduced quality audio file including the recorded sound and second recorded sound recorded using a second computer of the plurality of user computers, wherein the reduced quality audio file is created by the server computer by compressing a combined high-resolution audio file created by combining the high-resolution audio file and a second high-resolution audio file of the second recorded sound, wherein the combined high-resolution audio file is synchronized with the video content using the time stamp and a second time stamp within the second recorded sound; and
playing, at the first computer, the video content synchronized with the reduced quality audio file.

12. The method of claim 11, wherein the high-resolution audio file is recorded at a sample rate of at least 48 kHz and a resolution of at least 24 bits per sample.

13. The method of claim 11, wherein the step of transmitting the high-resolution audio file further comprises transmitting the chunks of audio data at least partially during playback of the video content.

14. (canceled)

15. The method of claim 11, wherein the reduced quality audio file includes the time stamp synchronized with the at least one frame of the video content.

16. The method of claim 11, wherein the remote audio recording session is instantiated on the first computer within a browser application and presented as web page environment.

17. The method of claim 11, wherein
the local memory comprises a cache associated with the browser application; and
the chunks of audio data are cleared from the cache upon termination of the web page environment in the browser application.

18. The method of claim 11, wherein the video content is received as a streaming video file for presentation in the browser program.

19. The method of claim 14 further comprising
transmitting metadata defining edits prepared using the reduced quality audio file for application to the high-resolution audio data to the master recording session.

20. The method of claim 14 further comprising receiving metadata from the master recording session defining edits to high-resolution audio prepared by another of the one or more users accessing the master recording session.

21. One or more non-transitory computer readable media including instructions which, when executed by one or more processors of a server computer connected to a plurality of user computers over a computer network, cause the server to perform a process comprising:
generating a master recording session corresponding to video content stored in a data storage accessible by the server computer;
providing access to the master recording session and the video content over the communication network to first and second computer devices at different physical locations from each other and from the server computer;
receiving first high-resolution audio data of a first audio recording corresponding to the video content and recorded using the first computer device during playback of the video content at the first computer device;
receiving second high-resolution audio data of a second audio recording corresponding to the video content and recorded using the second computer device during playback of the video content at the second computer device, wherein
the first high-resolution audio data includes a first time stamp synchronized with at least a first frame of the video content and the second high-resolution audio data includes a second time stamp synchronized with at least a second frame of the video content, and
the first high-resolution audio data and the second high-resolution audio data is received by the server computer as discrete, sequential chunks of audio data corresponding to short, sequential time segments of the recording;
combining the first high-resolution audio data and the second high-resolution audio data into a single high-resolution audio file synchronized with the video content based on the first time stamp and the second time stamp; and
saving the single high-resolution audio file to a storage device accessible by the server computer.

22. The non-transitory computer readable media of claim 21, wherein the process further comprises:
transforming the single high-resolution audio file into a reduced quality audio file; and
transmitting the reduced-quality audio file over the communication network to each of the first computer device and the second computer device.
